(19) United States
(12) Patent Application Publication
(10) Pub. No.: US 2023/0180286 A1
(43) Pub. Date: Jun. 8, 2023

(54) TRANSFERRING DATA FROM A SECOND NODE TO A FIRST NODE

(71) Applicant: Telefonaktiebolaget LM Ericsson (publ), Stockholm (SE)

(72) Inventors: Hjalmar Olsson, BROMMA (SE); Henrik Rydén, STOCKHOLM (SE)

(21) Appl. No.: 17/922,926

(22) PCT Filed: May 13, 2020
(86) PCT No.: PCT/EP2020/063311

§ 371 Date: Nov. 2, 2022

(51) Int. Cl. H04W 74/00

(52) U.S. Cl. CPC H04W 74/002

(57) ABSTRACT

A method in a first node of transferring data from a second node to a first node comprises receiving a message from the second node indicating that the second node has data to transfer to the first node. The method then comprises predicting a possible content of the data and sending the prediction of the possible content of the data to the second node. The method then comprises determining the data based on a response of the second node to receiving the prediction.

### TECHNICAL FIELD

This disclosure relates to methods, nodes and systems in a communications network. More particularly but non-exclusively, the disclosure relates to transferring data from a second node to a first node in a communications network.

### BACKGROUND

The time-frequency resource allocation between uplink and downlink can be divided using two different strategies in wireless communication. Time-division-duplex (TDD) which separates the transmissions in time, and frequency-division-duplex (FDD) that separates the transmissions in frequency. The split on the time-frequency resources will effectively decide on the available resources for uplink and downlink, allocating more uplink resources will lower the downlink bandwidth and vice versa. One method of splitting the traffic based on the ongoing traffic is dynamic TDD introduced for LTE/NR, where one could dynamically set the resource allocation in TDD operation.

The disclosure herein relates to transferring data in a communications network, more particularly it relates to transferring data when available downlink (DL) or uplink (DL) limits the communication performance. For example when the downlink supports 10 Gbit/s, while uplink is limited to hundreds of kbit/s (peak-throughput limited scenarios). The disclosure herein also relates to energy-limited scenarios whereby the energy consumption is higher for a node in either the DL or UL. Situations where such imbalance occurs is further explained below.

In wireless communication, the uplink and downlink communication performance between a device, such as a user equipment (UE), and a network node may be limited due to constraints such as:
Available time-frequency resources of uplink/downlink
TDD/FDD configuration
UE traffic pattern
Uplink/Downlink traffic size
Congestion due to traffic pattern from UEs served by same node
UE/network-node energy restrictions
Downlink/uplink receiver capabilities
Antenna array
Receiver sensitivity
Transmission power

Some example scenarios in which either the uplink or the downlink channel may limit the communication performance are given below.

Massive Internet of Things (IoT): To meet IoT design objectives, the Third Generation Partnership Project (3GPP) has standardized Narrowband IoT (NB-IoT) in Release 13 that has a system bandwidth of 180 kHz and targets improved coverage, long battery life, low complexity communication design, and network capacity that is sufficient for supporting a massive number of devices, one IMT-2020 target for Massive IoT is to support a density of devices of 1 million devices per square kilo-meter.

A major battery consuming procedure for an IoT device is the uplink transmission, where the coverage requirements leads to many repetitions for an uplink transmission at the device. In this example, the uplink is often limited due to the battery constraints of the device, while the downlink comprises of receiving the network node transmitted signal which is of less power consumption. Furthermore, the link-budget is better in the downlink since the IoT devices transmission power is much more limited in comparison to the base station transmit power.

Satellite systems: There is an ongoing resurgence of satellite communications, including interest in providing Internet access from space. The target services vary, from backhaul and fixed wireless, to transportation, to outdoor mobile, to IoT. Satellite networks could complement mobile networks on the ground by providing connectivity to underserved areas and multicast/broadcast services. To benefit from the strong mobile ecosystem and economy of scale, adapting the terrestrial wireless access technologies including LTE and NR for satellite networks is drawing significant interest. One problem with satellite systems is that uplink is much more challenging in comparison to downlink since UEs are more power limited in comparison to satellite transmission power.

Traffic patterns: The traffic generated for the new types of machine type devices may have very specific demands on communication. This is illustrated in FIG. 1 whereby, for example, a video camera 108 streaming video live may have a demand for a huge uplink traffic 104 to a node 102 but will have very limited needs of a downlink channel 106 able to handle massive transportations. Conversely, a printer 114, only used, for example, for printing photos may have opposite needs: huge downlink traffic 112 and far less uplink traffic 110. These are merely examples, and many devices have the same kind of very specific demands for uplink and downlink, both from a bandwidth and a round trip time perspective. In the case of operating these types of devices in FDD mode, large spectrum resources on the downlink or uplink channels respectively may go unutilized.

Theoretical throughput speeds: There may also be theoretical boundaries limiting communication performance, which may also show the imbalance between UL and DL. For example, for LTE advanced, the standard limits the theoretical peak speed at 1000 Mbit/s in the downlink and 500 Mbit/s in the uplink. For NB-IoT, the standard limits the theoretical peak speed to 62 kbit/s in the downlink and 27 kbit/s in the uplink.

### SUMMARY

As described above, there are many use cases in communications networks where data needs to be transferred between nodes with imbalanced UL/DL capabilities. There are also cases where a node with data to transfer is energy limited, thus making transmissions from the energy-limited node undesirable (or even impossible). Embodiments herein aim to provide improved methods and systems for transferring data between nodes in these scenarios, and others.

Thus, according to a first aspect there is a method in a first node of a communications network for transferring data from a second node to the first node. The method comprises i) receiving a message from the second node indicating that the second node has data to transfer to the first node; ii) predicting a possible content of the data;

iii) sending the prediction of the possible content of the data to the second node; and
iv) determining the data based on a response of the second node to receiving the prediction.

In this way, if the second node has limited battery or limited uplink capability or similar, it does not need to transmit the data to the first node. Rather, the first node can predict the content of the transmission, suggest this prediction to the second node and infer the contents of the data, based on the response of the second node (for example, the second node may acknowledge the prediction if it is correct). The data may thus be effectively communicated to (or deduced by) the first node, without the second node having to transmit the data directly. In this way, the larger resources (energy/downlink etc) of the first node may be leveraged in order to transfer the data.

Other advantages may include: (a) better energy efficiency for IoT devices where the uplink is much more energy constrained than the downlink; (b) also, in general, the link-budget is better for downlink due to the higher base station (BS) transmission power and beamforming capabilities, hence, one can pack more bits/s/hz in the downlink compared to the uplink; (c) use of the downlink for uplink limited scenarios improves spectral efficiency, in scenarios where the network is able to predict the uplink packet; (d) optimized design of hardware, software and network architecture in order to tailor them for what the device will use them for; (e) given the network properties of prioritised uplink or downlink, embodiments herein may help prevent the link from becoming a bottle neck by improving data transfer rates.

According to a second aspect there is a method in a second node of a communications network for transferring data from the second node to a first node. The method comprises v) sending a message to the first node indicating that the second node has data to transfer to the first node; vi) receiving from the first node, a prediction of a possible content of the data; vii) comparing the received prediction of the content of the data to the data; and viii) responding to the first node, based on the step of comparing.

According to a third aspect there is a first node in a communications network, suitable for transferring data from a second node to the first node. The first node comprises a memory comprising instruction data representing a set of instructions and a processor configured to communicate with the memory and to execute the set of instructions. The set of instructions, when executed by the processor, cause the processor to: i) receive a message from the second node that the second node has data to transfer to the first node; ii) predict a possible content of the data; iii) send the prediction of the possible content of the data to the second node; and iv) determine the data based on a response of the second node to receiving the prediction.

According to a fourth aspect there is a second node in a communications network, suitable for transferring data from the second node to a first node, wherein the second node comprises a memory comprising instruction data representing a set of instructions and a processor configured to communicate with the memory and to execute the set of instructions. The set of instructions, when executed by the processor, cause the processor to: v) send a message to the first node that the second node has data to transfer to the first node; vi) receive from the first node, a prediction of a possible content of the data; vii) compare the received prediction of the content of the data to the data; and viii) respond to the first node, based on the step of comparing.

According to a fifth aspect there is a computer program product comprising a computer readable medium, the computer readable medium having computer readable code embodied therein, the computer readable code being configured such that, on execution by a suitable computer or processor, the computer or processor is caused to perform the method of the first or second aspects.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 illustrates two scenarios where there is a discrepancy between uplink and downlink channel size between two devices communicating with a network node;

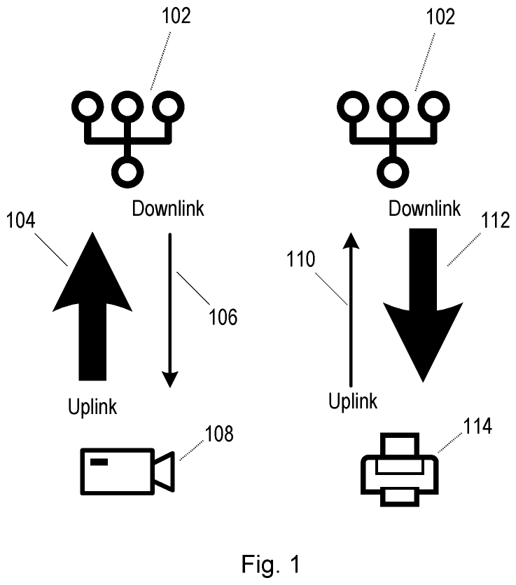

FIG. 2 illustrates a first node according to some embodiments herein;

FIG. 3 illustrates a method in a first node according to some embodiments herein;

FIG. 4 illustrates a second node according to some embodiments herein;

FIG. 5 illustrates a method in a second node according to some embodiments herein;

FIG. 6 illustrates a method in a first node according to an example embodiment herein;

FIG. 7 illustrates a method in a second node according to an example embodiment herein;

FIG. 8 illustrates an example embodiment wherein the second node comprises an aerial drone;

FIG. 9 illustrates an example signal diagram between an aerial drone and a network node according to some embodiments herein;

FIG. 10 illustrates an example embodiment wherein the second node comprises a temperature sensor;

FIG. 11 illustrates an example flow diagram according to some embodiments herein; and

FIG. 12 illustrates another example flow diagram according to some embodiments herein.

### DETAILED DESCRIPTION

As described briefly above, embodiments herein aim to improve upon methods for sending data from a second node to a first node, particularly in scenarios where it is undesirable (or impossible) for the second node to transmit the data to the first node directly. This may occur, for example, if the second node is energy limited or has limited uplink resources available.

Embodiments herein describe how to use a larger downlink to compensate for a limited uplink (or the other way around). It may be used, for example, in situations where the network and the client capabilities are tailored to use mainly uplink or downlink for certain devices. Some embodiments of the disclosure use machine learning to predict the uplink packet for a second node (such as a UE), for example in case of an area deployed with sensors, the sensor reports can be correlated, hence measures from one sensor can be used to predict other sensors. Also periodical sensor measurements can be used to predict the next packet for a sensor, similarly, previous camera image reports can be used to predict future image reports from e.g. a drone. A first node (e.g. a network node) can then transmit the predicted uplink data packet to the second node (e.g. device) in downlink, and the second node may feedback, for example, an ack/nack in order to confirm whether the predicted packet is correct. In this way, for example, the second node can deduce the content of the data that the first node has to transmit in the UL, without the second node having to transmit the data.

Embodiments herein relate to a communications network. Generally, the communications network (or telecommunications network) may comprise any one, or any combination of: a wired link (e.g. ASDL) or a wireless link such as Global System for Mobile Communications (GSM), Wideband Code Division Multiple Access (WCDMA), Long Term Evolution (LTE), WiFi, Bluetooth wireless technologies, New Radio (NR) or any other type of wireless link available now or in the future. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or Zig Bee standards.

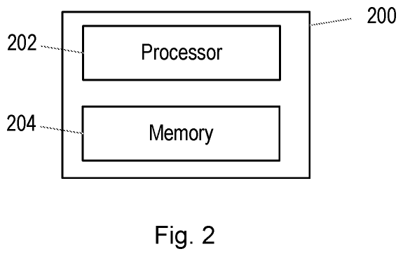

FIG. 2 shows a first node 200 in a communications network according to some embodiments herein for transferring data from a second node to the first node. The node 200 may comprise any component or network function (e.g. any hardware or software module) in the communications network suitable for performing the functions described herein.

In some embodiments, the first node may comprise a network node. For example the first node 200 may be configured to transfer (e.g. receive) data from another node or user equipment (UE) in the communications network. If the second node is a user equipment, the reception of data at the first node is typically referred to as the uplink reception. While the transmission of data to the second node from the first node is referred to as the downlink transmission.

In some embodiments therefore, the first node 200 may comprise equipment capable, configured, arranged and/or operable to communicate directly or indirectly with a UE (such as a wireless device) and/or other network nodes or equipment in the communications network to enable and/or provide wireless or wired access to the UE and/or to perform other functions (e.g., administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). Alternatively, the second node 400 may comprise a core network function such as, for example, core network functions in a Fifth Generation Core network (5GC).

In other embodiments, the first node 200 may comprise a wireless device or user equipment (UE). For example a UE may be configured to transfer data from another node or UE in the communications network. Thus, the methods herein may be used in downlink, uplink or sidelink communications.

A wireless device may comprise a device capable, configured, arranged and/or operable to communicate wirelessly with network nodes and/or other wireless devices. Unless otherwise noted, the term UE may be used interchangeably herein with wireless device (WD). Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a UE may represent a machine or other device that performs monitoring and/or measurements, and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. In another example, a UE may comprise an aerial vehicle, or drone. A UE as described above may represent the endpoint of a wireless connection, in which case the device may be referred to as a wireless terminal. Furthermore, a UE as described above may be mobile, in which case it may also be referred to as a mobile device or a mobile terminal.

The first node 200 may be configured or operative to perform any of the methods or functions described herein, such as any of the embodiments of the method 300 or the method 600 as described below. The node 200 may comprise a processor (e.g. processing circuitry or logic) 202. It will be appreciated that the node 200 may comprise one or more virtual machines running different software and/or processes. The node 200 may therefore comprise one or more servers, switches and/or storage devices and/or may comprise cloud computing infrastructure or infrastructure configured to perform in a distributed manner, that runs the software and/or processes.

As described in more detail below, in some embodiments herein, the first node 200 may need more CPU and memory in order to transfer the data from the second node when performing the method 300 described below (e.g. when compared with legacy data transfer methods). Therefore, in some embodiments, some steps of the method may be place in the cloud instead of local execution. In these cases, the deployment in the cloud may move capex to opex.

The processor 202 may control the operation of the node 200 in the manner described herein. The processor 202 can comprise one or more processors, processing units, multi-core processors or modules that are configured or programmed to control the node 200 in the manner described herein. In particular implementations, the processor 202 can comprise a plurality of software and/or hardware modules that are each configured to perform, or are for performing, individual or multiple steps of the functionality of the node 200 as described herein.

The node 200 may comprise a memory 204. In some embodiments, the memory 204 of the node 200 can be configured to store program code or instructions that can be executed by the processor 202 of the node 200 to perform the functionality described herein. Alternatively or in addition, the memory 204 of the node 200, can be configured to store any requests, resources, information, data, signals, or similar that are described herein. The processor 202 of the node 200 may be configured to control the memory 204 of the node 200 to store any requests, resources, information, data, signals, or similar that are described herein. It will be appreciated that the node 200 may comprise other components in addition or alternatively to those indicated in FIG. 2. For example, in some embodiments, the node 200 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 202 of node 200 may be configured to control such a communications interface to transmit to and/or receive from other nodes or network functions requests, resources, information, data, signals, or similar.

Briefly, in one embodiment, the first node 200 may be configured (e.g. programed or adapted) to: i) receive a message from a second node 400 that the second node has data to transfer to the first node 200; ii) predict a possible content of the data; iii) send the prediction of the possible content of the data to the second node 400; and iv) determine the data based on a response of the second node 400 to receiving the prediction.

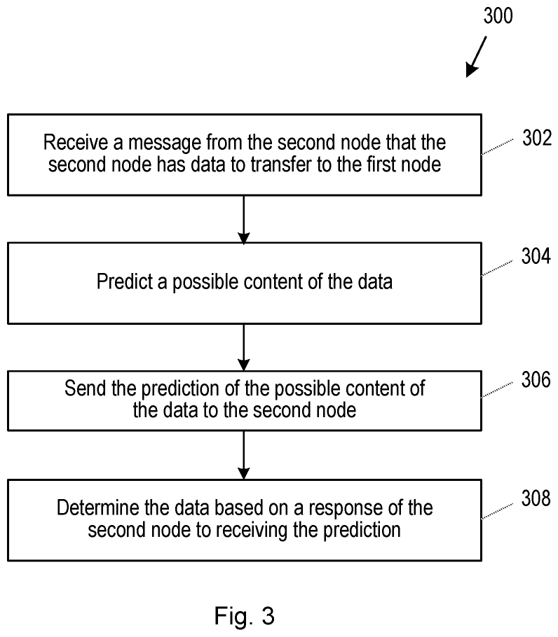

FIG. 3 shows a method 300 in a first node 200 according to some embodiments herein. Briefly the method comprises in a first block (or module) (i) receiving 302 a message from the second node 400 indicating that the second node 400 has data to transfer to the first node; in a second block block (or module) (ii) predicting 304 a possible content of the data; in a third block (or module) (iii) sending 306 the prediction of the possible content of the data to the second node; and in a fourth block or module, (iv) determining 308 the data based on a response of the second node 400 to receiving the prediction.

In this way, the first node 200 is able to determine or deduce the contents of the data that the second node 400 wishes to send to the first node 200, without the second node 400 having to transmit the data. This is may be used to conserve energy and/or resources of the second node 400, particularly if the second node is energy-limited, or if the second node has limited uplink resources available to it.

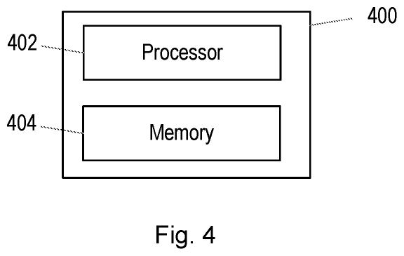

In more detail, the first node 200 may comprise a node such as the first node 200 described above with respect to FIG. 2. The second node may comprise a second node 400 as described below with respect to FIG. 4 and the method 500.

In any of the embodiments described herein, the methods may be performed responsive to a bandwidth for data transmission from the second node to the first node being below a threshold bandwidth, or responsive to a power requirement for the second node to transmit the data to the first node being above a threshold power.

For example, the methods 300 and 500 may be performed when the uplink from the second node 400 to the first node 200 is limited compared to the downlink from the first node to the second node. As noted above, the second node may comprise, for example, an aerial user equipment, UE, a battery constrained device or an internet of things, IoT, device. In another example, the communications network may comprise a non-terrestrial network (NTN). In such examples, the first node may comprise a satellite and the second node may comprise a terrestrial node.

In block i) there is a step of receiving 302 a message from the second node indicating that the second node has data to transfer to the first node. The message may comprise, for example, a scheduling request in LTE. In some embodiments, the message may comprise an indication of the size of the data (e.g. number of bits), or the type of data that is to be transferred. The message may further comprise an indication that the second node wishes to transfer the data using the methods 300 and 500 described herein. The message may further comprise one or more parameters for use in transferring the data using the methods 300 and 500 described herein.

In block ii) there is a step of predicting 304 a possible content of the data. In other words the first node predicts what the second node would like to send to the first node.

In some embodiments, predicting 304 a possible content of the data comprises the first node making a random prediction of the content of the data (e.g. a random selection from a plurality of possible or plausible contents of the data). In other words, the packet prediction model may comprise a random prediction. For example, with a packet size of N bits, the probability of correctly guessing a packet is 2\hat{ }−N. This may be used, for example, where the second node has a limited number of possible transmissions, or transmission content types that may be transmitted to the first node.

As an example, an IoT device may provide a daily status report comprising one of 4 possible status values. Thus, the first node may thus select one of the four possible status values (at random) in step 304.

In some embodiments, predicting 304 a possible content of the data comprises the first node 200 predicting the content of the data based on previous transmissions made by the second node 400. The previous transmissions may have been made by the second node 400 to the first node 200, or to any other node in the communications network. In other words, the packet prediction model may be based on the historical transmission of a device.

For example, in an embodiment where the second node comprises a UE that transmits a periodical reporting of a sensor data, the network may predict future values of the sensor data, based on the historical information (e.g. using trend analysis of the historical data, extrapolation of the historical data, averaging of the historical data or any other method of predicting future transmissions from historical transmissions).

In some embodiments, predicting 304 a possible content of the data comprises the first node predicting the content of the data based on previous transmissions made by another node, e.g. another node having similar characteristics to the second node. For example, the other node may be of the same type as the second node, or comprise a common type of sensor as the second node. In other words, the packet prediction model may be based on the historical transmissions of another device.

For example, in an area deployed with sensors, sensor reports may be correlated and measures from one sensor may be used to predict other sensors. In another example, where the second node comprises a drone, camera feeds from another drone may be used to predict a future image as recorded by the second node 400. In another example of UE location reports, past locations may be used to predict a future location.

In other embodiments, the step of predicting 304 a possible content of the data may comprise predicting a possible content of the data using a model trained using a machine learning process. The model may take as input features related to the second node and output a prediction of the possible content of data that the node wishes to transmit to the first node. Example input features include, for example, the time of day, location of the node, sensor capability of node, frequency of transmission, content of last transmission.

The model may be trained using training data. The training data may comprise examples of input values and corresponding ground truth or “correct” outputs. The training data may comprise previous data transferred to the communications network by the second node and/or previous data transferred to the communications network by other nodes, e.g. of the same (or similar) type as the second node.

The skilled person will be familiar with machine learning. Machine learning can be used to find a predictive function for a given dataset; the dataset is typically a mapping between a given input to an output. The predictive function (or mapping function) is generated in a training phase, where the training phase assumes knowledge of both the input and output. The test phase comprises predicting the output for a given (previously unseen) input. Applications of machine learning include, for example, curve fitting, facial recognition and spam filtering. In embodiments herein, the model may comprise any machine learning model that can be trained and used to predict the contents of future transmissions based on previous transmissions. For example, the model may comprise a supervised learning model, such as a neural network, random forest, decision tree, or any other supervised machine learning model.

In some embodiments, the accuracy of predictions made by the model may be determined (or calculated). The methods 300 and 500 may then be performed responsive to determining that the model accuracy (e.g. predictions made by the model) is above a threshold model accuracy. If the model accuracy is less than the threshold model accuracy then, for example, a legacy procedure may be used to transfer the data instead.

Block (iii) comprises sending 306 the prediction of the possible content of the data to the second node (e.g. in a second message).

In some embodiments, a plurality of predictions of the possible content of the data may be made. To accomplish the best prediction of the payload, a prediction with the highest possible probability of success is what the network node may transmit. For example, block iii) may comprise sending a prediction with the highest accuracy (or lowest estimated error) to the second node.

In examples where the first node predicts 304 the same package for more than one second node (e.g. predicts the same package for multiple UEs), the network node can broadcast the predicted package to multiple UEs. Using broadcast enables multiple UEs to listen to the same downlink resources, leading to more efficient signaling of data, if two or more UEs intend to send similar uplink packages.

One or more configuration parameters may also be sent in block iii), for example, indicating how the second node should respond in order to confirm the prediction is correct or incorrect.

In block iv) the method comprises determining 308 the data based on a response of the second node to receiving the prediction. Generally, for example, the second node may respond to the first node in such a manner as to indicate that the prediction is correct, in which case the first node is aware of (or “knows”) the data that the second node wished to transfer, without the second node actually having to transmit the data, thus saving power and/or resources of the second node that would otherwise be needed to transmit the data to the first node.

In some embodiments, the step of determining the data may therefore comprise receiving an indication from the second node that the prediction is correct, and using the prediction as the data. E.g. using the prediction in a subsequent process (in place of the data) as if it had been transmitted to the first node by the second node.

The second node 400 may indicate to the first node 200 that the prediction is correct in various ways. For example, the second node (e.g. a UE) may respond with an ACK/NACK dependent on whether the predicted packet matches the intended one. Thus the first node 200 may receive an acknowledgement (e.g. “ACK” message) that the second node 400 has received the prediction and this may be taken to indicate that the prediction is correct. In another embodiment, the UE may respond with ACK if the predicted package is good enough. A hash function to verify data integrity for unintentional corruption could be used. This is something that could be performed with MD5 or a similar algorithm. It is generally quick and already supported by most systems. It is also important to think about the needed accuracy of the data. If the data to be transferred comprises an image, it may be good enough if 80% of the pixels are correct, for example.

In another embodiment, the step of receiving an indication from the second node that the prediction is correct may comprise not receiving a non-acknowledgement message from the second node within a predefined time period after the step of sending the prediction of the data to the second node. In other words, if the first node 200 does not receive any messages from the second node 400 within a predetermined time interval from the first node 200 sending the prediction to the second node 400 in block iii), then the first node 200 may assume that the prediction is correct and use the prediction (e.g. in place of data transmitted from the second node) in a subsequent process. This may be particularly energy efficient for the second node 400.

As noted above, in some embodiments, the step of sending 306 the prediction to the second node 400 may comprise sending a plurality of predictions to the second node 400. In such embodiments, step (iv) of determining the data may comprise receiving an indication from the second node that a particular one of the plurality of predictions is correct (e.g. an enumerated value). The method 300 may then further comprise using the indicated particular one of the predictions as the data. In one embodiment, if the network transmits more than one predicted package, a UE may feedback an index of the correct predicted package, or an indication that none of them are correct.

Alternatively, step (iv) of determining 306 the data may comprise receiving an indication from the second node that a particular one of the predictions is closest to the content of the data (e.g. within a threshold tolerance of being equal to the content of the data). The method 300 may thus further comprise using the indicated particular one of the predictions as the data. In this manner, a plurality of options may be presented to the second node and the second node may indicate the correct, or closest option.

If no indication is received from the second node that the prediction is correct, then the first node may deduce that the prediction is incorrect, e.g. that the predicted contents of the data do not match the actual data that the second node wishes to transfer to the first node. Generally, in this case, the first node 200 may repeat steps ii)-iv) for other predictions of the possible content of the data, until an indication is received from the second node 400 that one of the other predictions is correct. For example, the second node may only respond to acknowledge a correct prediction (ACK), and the network node may implicitly understand that it is to transmit a new package in the case that an ACK message has not arrived within a time_out timer. In another embodiment, the UE only responds if NACK, and the network node implicitly understand that the packet was correct if a NACK hasn't been received. The selection of whether to use implicit ack or nack can depend on the packet prediction accuracy. In this way, a first node may repeatedly send predictions of the content of the data to the second node until the prediction is correct, thus a larger energy reserve, or larger DL/UP channel of the first node may be utilised (at no detriment to the first node 200) to determine the content of the data without the second node 400 having to transmit it.

In an example embodiment, the method 300 comprises determining whether the second node has responded to a message sent in step iii) within a predetermined time period. If no response is received, the first node determines (or deuces) that the data is different to the prediction. The method may further comprise repeating steps ii)-iv) for other predictions of the possible content of the data, until an indication is received from the second node that one of the other predictions is correct. This may be particularly energy efficient for the second node as the second node as the second node may merely send an initial message to the first node to initiate the transfer and subsequently e.g. an acknowledgement when a correct prediction is received, in order to transfer the data to the first node.

In embodiments where steps ii)-iv) are repeated for other predictions of the possible content of the data, they may be repeated for the other predictions of the possible content of the data, in an order reflecting a relative probability of each of the other predictions being correct. In other words, the predictions that are more likely to be correct are prioritised over predictions that are less likely to be correct.

If no indication is received from the second node that the prediction is correct, then the method may further comprise sending a message to the second node to configure (e.g. instruct) the second node to transmit the data to the first node. For example, using the normal or legacy procedure. In this way, the method may revert back to the normal procedure if the first node is unable to correctly predicted the contents of the data, or if the network node packet prediction model outputs a high uncertainty of the correct uplink packet.

Turning now to the second node in more detail, FIG. 4 illustrates a second node 400 in a communications network according to some embodiments herein for transferring data from the second node to a first node (such as the first node 200). The second node 400 may comprise any component or network function (e.g. any hardware or software module) in the communications network suitable for performing the functions described herein.

The second node 400 may comprise any of the node types described above with respect to the first node.

For example, in some embodiments, the second node may comprise a network node. For example, the second node 400 and the method 500 (described below) may be used to transfer data from a network node to another node or user equipment (UE) in the communications network. For example, the second node may comprise any one of: an access point (AP) (e.g., radio access point), base station (BS) (e.g., radio base station, Node B, evolved Node B (eNB) and NR NodeB (gNB)). Alternatively, the second node 400 may comprise a core network function such as, for example, core network functions in a Fifth Generation Core network (5GC).

In other embodiments, the second node 400 may comprise a wireless device or user equipment (UE). For example the second node 400 and the method 500 may be used to transfer data from a UE in the communications network to another network node or UE.

Examples of wireless devices and UEs were given above with respect to the first node 200 and these will be understood to apply equally to the second node 400.

The second node 400 may be configured or operative to perform the methods and functions described herein, such as the method 500 described below. The second node 400 may comprise a processor (or logic) 402. It will be appreciated that the second node 400 may comprise one or more virtual machines running different software and/or processes. The second node 400 may therefore comprise one or more servers, switches and/or storage devices and/or may comprise cloud computing infrastructure or infrastructure configured to perform in a distributed manner, that run the software and/or processes.

The processor 402 may control the operation of the second node 400 in the manner described herein. The processor 402 can comprise one or more processors, processing units, multi-core processors or modules that are configured or programmed to control the second node 400 in the manner described herein. In particular implementations, the processor 402 can comprise a plurality of software and/or hardware modules that are each configured to perform, or are for performing, individual or multiple steps of the functionality of the second node 400 as described herein.

The second node 400 may comprise a memory 404. In some embodiments, the memory 404 of the second node 400 can be configured to store program code or instructions that can be executed by the processor 402 of the second node 400 to perform the functionality described herein. Alternatively or in addition, the memory 404 of the second node 400, can be configured to store any requests, resources, information, data, signals, or similar that are described herein. The processor 402 of the second node 400 may be configured to control the memory 404 of the second node 400 to store any requests, resources, information, data, signals, or similar that are described herein.

It will be appreciated that the second node 400 may comprise other components in addition or alternatively to those indicated in FIG. 4. For example, the second node 400 may comprise a communications interface. The communications interface may be for use in communicating with other UEs and/or nodes in the communications network, (e.g. such as other physical or virtual nodes such as the node 200 described above). For example, the communications interface may be configured to transmit to and/or receive from nodes or network functions requests, resources, information, data, signals, or similar. The processor 402 of second node 400 may be configured to control such a communications interface to transmit to and/or receive from nodes or network functions requests, resources, information, data, signals, or similar.

The second node 400 is configured to interact with the first node 200 in a reciprocal manner to that described above with respect to the first node 200 and the method in the first node 300 as described above, and the detail therein will be understood to apply equally to the node 40 and the method 500 as appropriate.

Briefly, the second node 400 may be configured (e.g. programed or adapted) to: v) send a message to the first node 200 indicating that the second node 400 has data to transfer to the first node 200; vi) receive from the first node 200, a prediction of a possible content of the data; vii) compare the received prediction of the content of the data to the data; and viii) respond to the first node 200, based on the step of comparing.

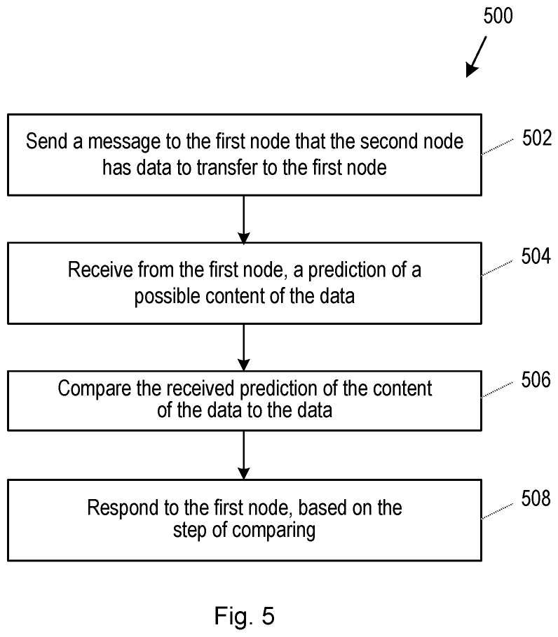

FIG. 5 shows a method 500 in a second node 400 according to some embodiments herein. Briefly the method comprises in a first block (or module) (v) sending 502 a message to the first node 200 indicating that the second node 400 has data to transfer to the first node 200; vi) receiving 504 from the first node 200, a prediction of a possible content of the data; vii) comparing 506 the received prediction of the content of the data to the data; and viii) responding 508 to the first node 200, based on the step of comparing.

In more detail, the first node may comprise a node such as the first node 200 described above with respect to FIG. 2. The second node may comprise a second node as described above with respect to FIG. 4.

In some embodiments, the step of responding to the first node, based on the step of comparing may comprise indicating to the first node that the prediction is correct if the received prediction of the content of the data is equal to the data.

Different methods that the second node may indicate to the first node that the prediction is correct were described above with respect to step 208 of the method 200 and the detail therein will be understood to apply equally to the method 400.

For example, indicating to the first node that the prediction is correct may comprise sending an acknowledgement that the second node has received the prediction to the first node. In another example, indicating to the first node that the prediction is correct may comprise refraining from sending a non-acknowledgement message to the first node within a predefined time period after receiving the prediction of the data from the first node.

In some embodiments as described above with respect to the first node 200 and the method 300, the step of receiving from the first node, a prediction of a possible content of the data may comprise receiving a plurality of predictions from the first node (e.g. an enumerated list of predictions).

The step of responding to the first node, based on the step of comparing may thus comprise sending an indication to the first node that a particular one of the predictions is correct. In other embodiments, the step of responding to the first node, based on the step of comparing may comprise sending an indication to the first node of a particular one of the predictions that is closest to the content of the data.

In some embodiments, the second node 400 may wish to transfer an image to the first node 200. E.g. the data may comprise an image. In such embodiments, the step of responding to the first node, based on the step of comparing may comprise indicating to the first node that the prediction is correct if the received prediction is correct to within a predetermined accuracy threshold. The predetermined accuracy threshold may comprise a threshold such as, for example, 80% correct, 85% correct, 90% correct, or any other percentage. In other words, the accuracy could be measured in percentage of correct bits and thus the predicted image does not necessarily need to be completely equal to the image that the second node wishes to transfer.

In some embodiments, the step of responding to the first node, based on the step of comparing may comprise not responding to the first node if the received prediction is incorrect or if the accuracy of the received prediction is less than a predetermined accuracy threshold. As described above, this may be based on a timer. For example, if the second node makes no response during a given time period after receiving the prediction, the first node may send another prediction of the possible content of the data. The first node may repeat this until the second node provides a positive response that one of the other predictions is correct. This may be very energy efficient for the second node.

The methods 300 and 500 as described above thus provide an energy and resource efficient manner in which to transfer data from a second node to a first node.

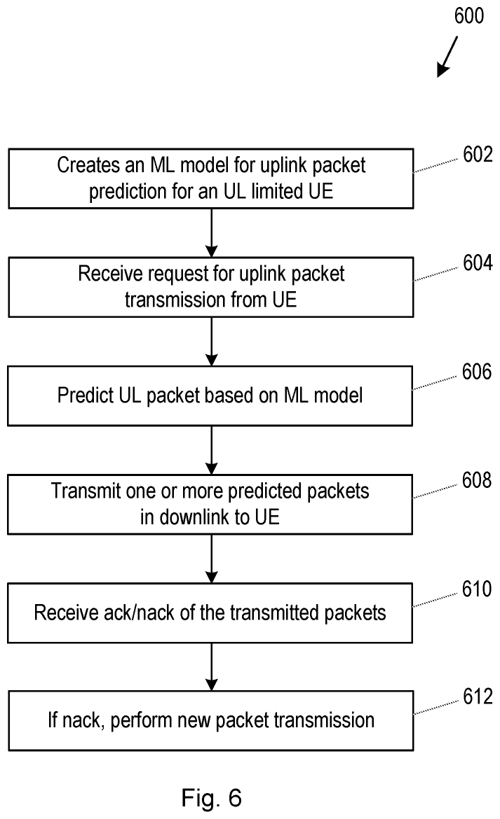

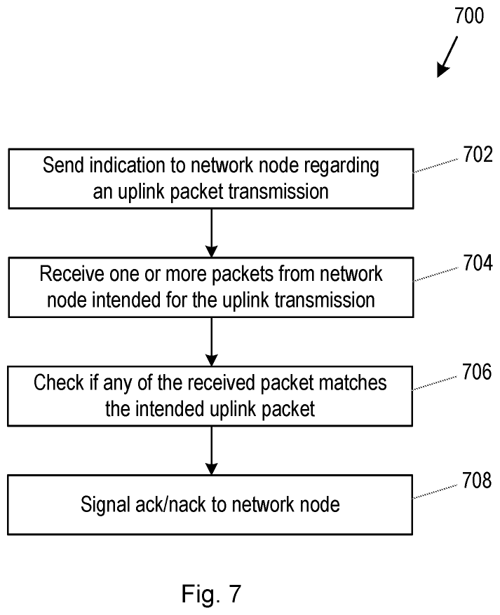

Turning now to other embodiments, FIGS. 6 and 7 illustrate a particular embodiment of the methods 300 and 500 described above. In this embodiment the first node comprises a network node and the second node comprises an UL limited UE.

The first node creates (e.g. trains) a machine learning (ML) model to predict packets for the UL limited UE in step 602. The UE sends an indication to the network node that it has data to transfer to the first node 702. This is received by the network node 604. The network node then predicts 606 the content of the data, using the trained ML model and sends the prediction of the possible content of the data to the UE in the downlink 608. This is received by the UE in step 704. The UE compares the prediction to the actual UL transmission that the UE wished to transmit and checks whether any of the received packet(s) match the intended UL transmission in step 706. The UE then sends 708 an ACK/NACK message to the network node dependent on whether the prediction is correct. The network node receives 610 the ACK/NACK of the transmitted packets. If the network node receives a NACK, it may repeat steps 606-610 for a new prediction 612.

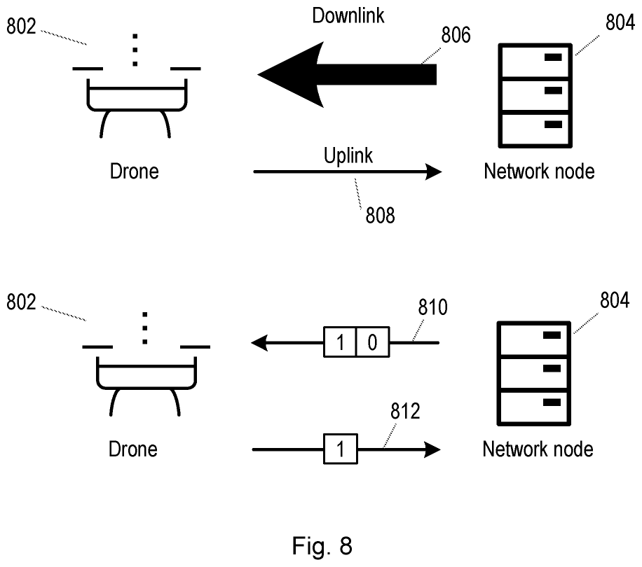

Turning to FIG. 8, in an example embodiment, the first node 804 comprises a network node (e.g. a base station, eNodeB, GNodeB etc.) and the second node comprises a transportation drone 802. The network node 804 has large DL capabilities 806 and the drone has low UL capability 808. The transportation drone 802 has a very limited need for uplink. The only communication need of the drone is to get flight instructions from the network node 804 about how and where to fly. The only purpose of the uplink from the drone to the backend is in the shape of replies assuring the network node that the drone has receive the information sent to it. In this embodiment, one would like to limit the uplink transmissions of the drone as much as possible since it has limited UL capability (and this can drain the energy of the device).

Take a scenario where the traffic pattern of the drone 802 changes, and the size of the uplink traffic is dramatically increased. The drone has a very limited uplink available but will of course try to send the data. In embodiments herein, it may ask the network node 804 for upload help.

FIG. 8 shows an example where a network node 804 uses a random packet predictor to predict the UL data of the drone. In this example, the network node randomly sends 2 bits 810 to the Drone 802 and receives a one-bit acknowledgement 812 upon a correct prediction. In case the predicted package is not correct, the network waits a time denoted “Time_out”, this means that the added latency is at most 3*time-out in the worst scenario. This means that the network node has a probability of 0.25 of a successful prediction.

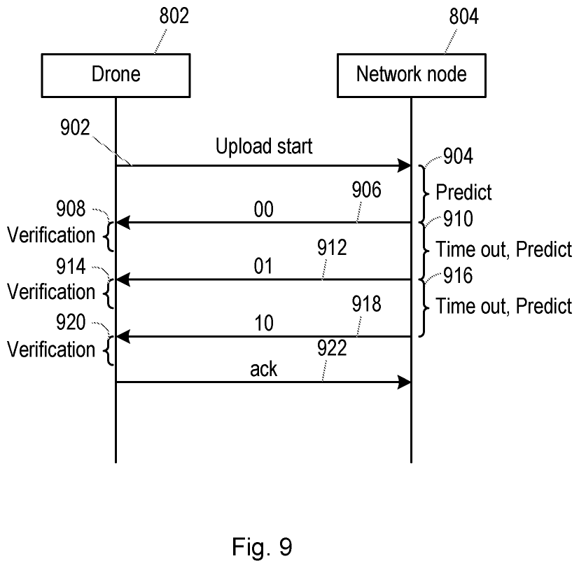

FIG. 9 illustrates a sequence diagram showing a process according to some embodiments. The network node 804 performs the method 300 above and the drone 802 performs the method 500 described above. The network node 804 receives a message 902 from the drone 802 indicating that the node has data to transfer to the network node. The network node predicts 904 2 bits as a possible content of the data and sends 906 these to the drone. In this embodiment, the drone is configured to only acknowledge a correct prediction.

Thus the drone compares the received prediction of the content of the data to the data 908. If the prediction is different, no ack message is sent. After a predetermined time period, the network node 804 makes a new prediction 910 and sends this to the node in step 912. This process is repeated 914, 916, 918, 920 until the network node makes a correct prediction and the Drone sends an acknowledgement message 922. In this example, the drone has to spend 1 bit to acknowledge the correct prediction. Since the probability of a correct prediction is 0.25 the network node needs to transport 4 bits on average to get an acknowledgement from the Drone. Under these circumstances the drone will upload 2 bits of data to the upload cost of 1 bit. The speed of the verification is very important. Let's imagine the situation where the downlink has the speed of 10 Gb/s and the uplink has a speed of 10 kb/s. Under those circumstance quite a lot of downlink attempts can be done and still increase the uplink speed.

This method may further be used, for example, in a situation where the highest possible bandwidth is required for an uplink transportation of data. For example, where the data transportation is an emergency. Nothing else matters, all available resources needs to be focused on one single mission: sending data. For instance, imagine a drone about to crash in the middle of a lake or a car that has caught fire. The device only has a short amount of time before it is lost. During this short amount of time the device wants to send every piece of interesting information it has available to a safe location. Transporting the contents of the black box, create a backup of the data only located on the device. It is important to remember that this is not the standard procedure. The communication system is not supposed to always act like this. Embodiments herein enable the use of the bandwidth of a dedicated downlink for uplink in FDD mode in such scenarios.

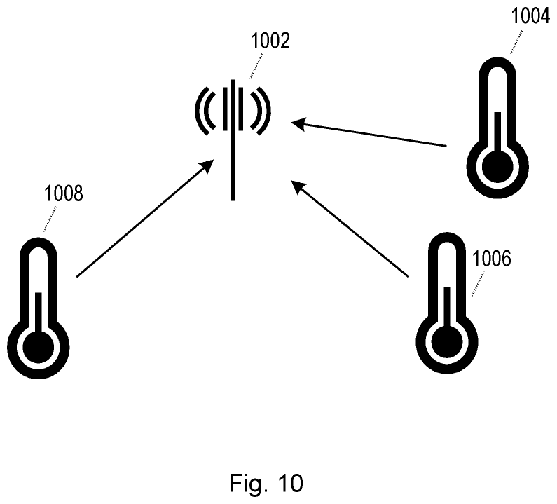

Turning to FIG. 10, in another example, temperature sensors 1004, 1006, 1008 may be deployed and report to a network node 1002. In this example, network node 1002 (e.g. the first node) first collects measurements from the three temperature sensors (second nodes) using existing methods for IoT such as NB-IoT. Next the network detects that sensor 1004 and 1006 are providing similar sensor readings, e.g., they are correlated. The network therefore creates an ML model for predicting sensor readings from 1004 based on 1006, or vice versa, for reducing the energy consumption at sensor 1004, by predicting its UL packets. After building the model, whenever the sensor 1004 requests to send an UL packet to the network node, the network predicts the said packet using sensor 1006 readings and sends a message comprising the predicted packet to sensor 1004. Based on the sensor device feedback ACK/NACK, the network node determines whether the prediction(s) were correct. The network node sends a new packet if NACK.

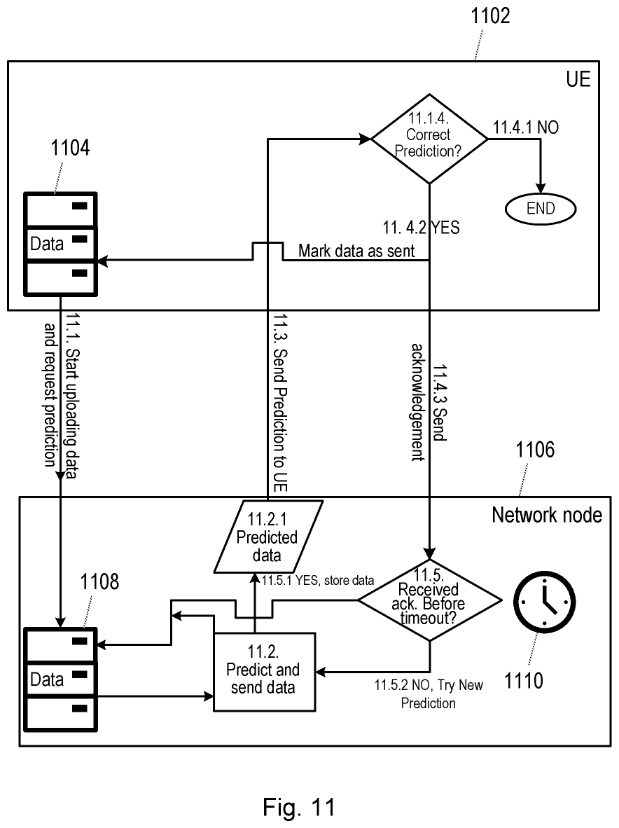

Turning now to FIG. 11, which shows a flow chart according to an example embodiment of transferring data from a second node comprising a UE 1102 to a first node comprising a network node 1106. The flow chart illustrates the following steps:

11.1. The UE starts an upload over the limited uplink and notifies the network node to start the prediction of data.
11.2. The network node will start prediction of the data. One input to the prediction may be the data already received from the UE.
11.2.1 The predicted data will be sent to the UE for verification.
11.3. The predicted data will be sent and received by the UE.
11.4. The UE will determine if the data is correct (enough).
11.4.1 If the UE finds the data incorrect it will do nothing and let the network node time out.
11.4.2 If the UE finds the data correct (enough) it will immediately send an acknowledgement back to the network node
11.4.3 It is important in this embodiment that the response back to the network node arrives before the timeout happens.
11.5. The network node will wait for an acknowledgement for a certain amount of time.
11.5.1 If an acknowledgement is received before the timeout; the predicted data is saved as received from the UE.
11.5.2 If an acknowledgement is not received before the time out prediction of a new data set is started and then sent to the UE.

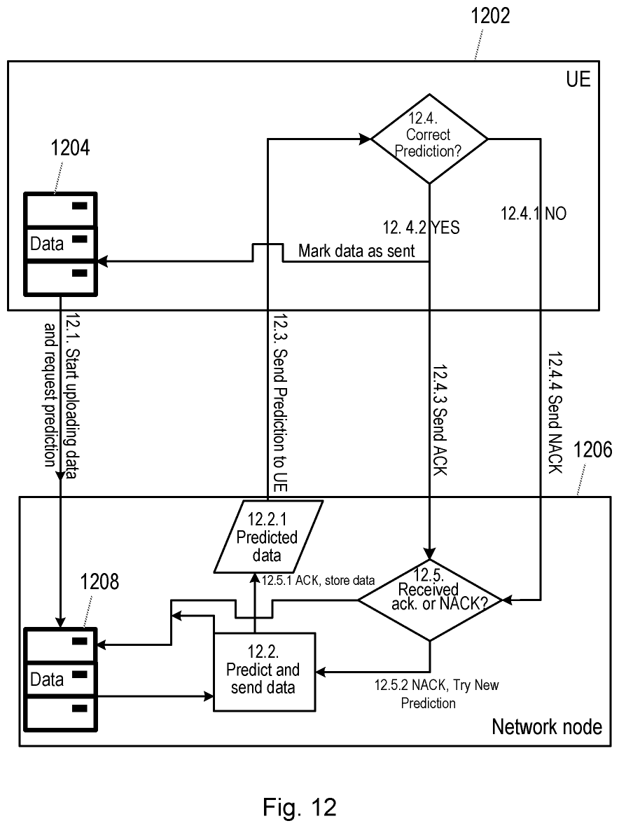

Turning now to FIG. 12, which shows a flow chart according to an example embodiment of transferring data from a second node comprising a UE 1202 to a first node 1206 comprising a network node. In this embodiment NACK is implicitly fed back using a time-out. The flow chart illustrates the following steps:

12.1. The UE starts an upload over the limited uplink and notifies the network node to start the prediction of data.
12.2. The network node will start prediction of the data. One input to the prediction may be data already received from the UE.
12.2.1 The predicted data will be sent to the UE for verification.
12.3. The predicted data will be sent and received by the UE.
12.4. The UE will investigate if the data is correct (enough).
12.4.1 If the UE finds the data incorrect it will send a NACK back to the network node.
12.4.2 If the UE finds the data correct (enough) it will immediately send an acknowledgement back to the network node

### 12.4.3 ACK

### 12.4.4 NACK

12.5. The network node will receive the response from the UE.
12.5.1 If an acknowledgement is received; the predicted data is saved as received from the UE.
12.5.2 If a negative acknowledgement is received prediction of a new data set is started and then sent to the UE.

Turning to another embodiment there is provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method in a first node of a communications network for transferring data from a second node to the first node, the method comprising:
i) receiving a message from the second node indicating that the second node has data to transfer to the first node;
ii) predicting a possible content of the data;
iii) sending the prediction of the possible content of the data to the second node; and
iv) determining the data based on a response of the second node to receiving the prediction.

2. The method as in claim 1 wherein the step of determining the data comprises:
receiving an indication from the second node that the prediction is correct; and
using the prediction as the data.

3. The method as in claim 2 wherein the step of receiving an indication from the second node that the prediction is correct comprises:
receiving an acknowledgement message from the second node; or
not receiving a non-acknowledgement message from the second node within a predefined time period after performing step (iii) of sending the prediction of the data to the second node.

4. The method as in claim 1 wherein the step of sending the prediction of the possible content of the data to the second node comprises sending a plurality of predictions to the second node.

5. The method as in claim 4 wherein the step of determining the data comprises:
receiving an indication from the second node that a particular one of the plurality of predictions is correct; and
using the indicated particular one of the predictions as the data.

6. The method as in claim 4 wherein the step of determining the data comprises:
receiving an indication from the second node that a particular one of the predictions is closest to the content of the data; and
using the indicated particular one of the predictions as the data.

7. The method as in claim 1 wherein the step of determining the data comprises:
determining whether the second node has responded to a message sent in step iii) within a predetermined time period; and
if no response is received, determining that the data is different to the prediction.

8. The method as in claim 1 further comprising repeating steps ii)-iv) for other predictions of the possible content of the data, until an indication is received from the second node that one of the other predictions is correct.

9. The method as in claim 8 wherein the steps ii)-iv) are repeated for the other predictions of the possible content of the data, in an order reflecting a relative probability of each of the other predictions being correct.

10. The method as in claim 7 further comprising:
sending a message to the second node to configure the second node to transmit the data to the first node.

11. The method as in claim 1 wherein the step of predicting a possible content of the data comprises: predicting a possible content of the data using a model trained using a machine learning process.

12. The method as in claim 11 wherein the model has been trained using training data comprising:
previous data transferred to the communications network by the second node; and/or
previous data transferred to the communications network by other nodes of the same type as the second node.

13. A method in a second node of a communications network for transferring data from the second node to a first node, the method comprising:
v) sending a message to the first node indicating that the second node has data to transfer to the first node;
vi) receiving from the first node, a prediction of a possible content of the data;
vii) comparing the received prediction of the content of the data to the data; and
viii) responding to the first node, based on the step of comparing.

14. The method as in claim 13 wherein the step of responding to the first node, based on the step of comparing comprises:
indicating to the first node that the prediction is correct if the received prediction of the content of the data is equal to the data.

15. The method as in claim 13 wherein the data comprises an image and wherein the step of responding to the first node, based on the step of comparing comprises:
indicating to the first node that the prediction is correct if the received prediction is correct to within a predetermined accuracy threshold.

16. The method as in claim 14 wherein indicating to the first node that the prediction is correct comprises:
sending an acknowledgement to the first node; or
refraining from sending a non-acknowledgement message to the first node within a predefined time period after receiving the prediction of a possible content of the data from the first node in step vi).

17. The method as in claim 13 wherein the step of receiving from the first node, a prediction of a possible content of the data comprises receiving a plurality of predictions from the first node.

18. The method as in claim 17 wherein the step of responding to the first node, based on the step of comparing comprises:
sending an indication to the first node that a particular one of the predictions is correct.

19. The method as in claim 17 wherein the step of responding to the first node, based on the step of comparing comprises:
sending an indication to the first node of a particular one of the predictions that is closest to the content of the data.

20. The method as in claim 13 wherein the step of responding to the first node, based on the step of comparing comprises: not responding to the first node if the received prediction is incorrect or if the accuracy of the received prediction is less than a predetermined accuracy threshold.

21-30. (canceled)
